(19) United States
(12) Patent Application Publication
(10) Pub. No.: US 2025/0298555 A1
(43) Pub. Date: Sep. 25, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Hisao KOMAZAWA, Kanagawa (JP); Akiho YASUDA, Kanagawa (JP)

(73) Assignee: FUJIFILM Business Innovation Corp., Tokyo (JP)

(21) Appl. No.: 18/809,454

(22) Filed: Aug. 20, 2024

(30) Foreign Application Priority Data
Mar. 22, 2024 (JP) 2024-046553

(51) Int. Cl. G06F 3/12

(52) U.S. Cl. CPC G06F 3/1208; G06F 3/1234

(57) ABSTRACT

An information processing system includes a processor configured to: print subsequent printed material while inspecting print quality of printed material; and in a case of not continuously printing the printed material of a subsequent job after a preceding job on the basis of purge settings related to a method of delivering printed material with an inspection result of rejected for the preceding job and the subsequent job, start the printing of the printed material of the subsequent job after the preceding job is completed.

### CROSS-REFERENCE TO RELATED APPLICATIONS

This application is based on and claims priority under 35 USC 119 from Japanese Patent Application No. 2024-046553 filed Mar. 22, 2024.

### BACKGROUND

### (i) Technical Field

The present disclosure relates to an information processing system, an information processing method, and a non-transitory computer readable medium.

### (ii) Related Art

Japanese Unexamined Patent Application Publication No. 2023-039712 discloses an inspection device that inspects the quality of printed material printed by a printer using a reference image and a scanned image of the printed material, the inspection device characterized by including: first acquiring means that acquires the reference image; second acquiring means that acquires the scanned image; selecting means that selects whether an image before printing, which is used in the printing of the printed material, or the scanned image is to be used as the reference image when inspecting the quality of the printed material; and UI means that, if a difference is detected as a result of a comparison between the image before printing and the scanned image, displays a reference image selection screen including the image before printing and the scan image, and accepts user input as to whether or not the detected difference is a defect, wherein the selecting means selects the reference image on the basis of the user input accepted by the UI means.

Japanese Unexamined Patent Application Publication No. 2022-146528 discloses an inspection device that compares a reference image with printed material that has been printed to inspect the printed material, the inspection device characterized by including control means that exclusively controls, as an inspection mode of the inspection, a mode in which the inspection mode switches the delivery destination of printed material deemed defective, and an inspection job that inspects printed material of which each copy is formed from a plurality of printed material or an inspection type that inspects printed material that is sequential in nature.

### SUMMARY

Aspects of non-limiting embodiments of the present disclosure relate to reducing the amount of waste in printed material when printed material with an inspection result of rejected occurs in a preceding job compared to the case in which a mode of printing the printed material of a subsequent job is always executed while inspecting the quality of the printed material of the preceding job.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing system including a processor configured to: print subsequent printed material while inspecting print quality of printed material; and in a case of not continuously printing the printed material of a subsequent job after a preceding job on the basis of purge settings related to a method of delivering printed material with an inspection result of rejected for the preceding job and the subsequent job, start the printing of the printed material of the subsequent job after the preceding job is completed.

### BRIEF DESCRIPTION OF THE DRAWINGS

An exemplary embodiment of the present disclosure will be described in detail based on the following figures, wherein:

FIG. 1 is a diagram illustrating a schematic configuration of an image forming system according to an exemplary embodiment;

FIG. 2 is a diagram (1 of 2) for explaining operations by the image forming system illustrated in FIG. 1;

FIG. 3 is a diagram (2 of 2) for explaining operations by the image forming system illustrated in FIG. 1;

FIG. 4 is a diagram (1 of 2) for explaining operations in the printing of multiple jobs by the image forming system illustrated in FIG. 1;

FIG. 5 is a diagram (2 of 2) for explaining operations in the printing of multiple jobs by the image forming system illustrated in FIG. 1;

FIG. 6 is a block diagram illustrating a hardware configuration of the image forming system illustrated in FIG. 1;

FIG. 7 is a functional block diagram of the image forming system illustrated in FIG. 1;

FIG. 8 is a diagram illustrating a schematic configuration of a printing system according to an exemplary embodiment;

FIG. 9 is an example of a purge settings screen;

FIG. 10 is a diagram for explaining operations by the image forming system illustrated in FIG. 1;

FIG. 11 is an example of a table illustrating correspondences between combinations of a preceding job and a subsequent job and the availability of continuous printing;

FIG. 12 is an example of an input screen for changing combinations of a preceding and a subsequent job for which continuous printing is not to be performed; and

FIG. 13 is a flowchart illustrating the flow of a continuous printing process in the image forming system illustrated in FIG. 1.

### DETAILED DESCRIPTION

The following describes an exemplary embodiment while referring to the drawings.

### Overview of Image Forming System

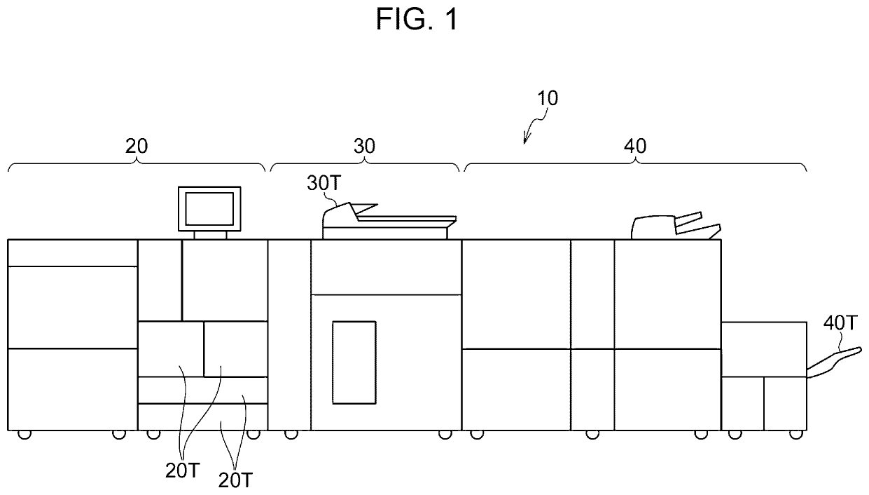

FIG. 1 illustrates an image forming system 10 according to the exemplary embodiment. The image forming system 10 includes a printer 20, an inspection device 30, and a finishing device 40. Note that the image forming system 10 is an example of an information processing system and an information processing apparatus.

### Printer

The printer 20 has multiple storage trays 20T for storing paper. The printer 20 is provided with a printing function that prints images onto paper supplied from one storage tray 20T among the multiple storage trays 20T.

### Inspection Device

The inspection device 30 is provided with an inspection function that receives paper onto which an image has been printed from the printer 20 and inspects the print quality of the received paper that has been printed upon (printed material). The inspection device 30 determines whether or not the printed material received from the printer 20 has an abnormality, such as corner creases, printing smudges, or misalignment.

Specifically, the inspection device 30 has a purge tray 30T into which printed material is delivered. The inspection device 30 receives from the printer 20 a reference image (correct image), such as a rasterized image generated on the basis of image data printed onto paper. The inspection device 30 also scans an image of the printed material received from the printer 20. The inspection device 30 then compares the reference image received from the printer 20 with an inspection image such as a rasterized image based on a scanned image, and determines whether or not the printed material has an abnormality.

As a result, upon determining that the printed material has an abnormality, the inspection device 30 sets the inspection result to rejected and delivers the printed material into the purge tray 30T. On the other hand, upon determining that the printed material does not have an abnormality, the inspection device 30 sets the inspection result to accepted and supplies the printed material to the finishing device 40. Note that the purge tray 30T is an example of a reject delivery unit.

### Finishing Device

The finishing device 40 performs various types of finishing processes, such as folding, stapling, hole-punching, and booklet-making, on the printed material inspected by the inspection device 30, and delivers the finished printed material into a predetermined delivery tray 40T. Note that the content of the processes by the finishing device 40 may be changed, as appropriate. Also, the delivery tray 40T is an example of a printed material delivery unit.

### Continuous Printing

The image forming system 10 has a continuous printing function. In continuous printing, for example, multiple consecutive printed materials are printed continuously while inspecting the print quality. Specifically, with continuous printing, in the printer 20, an image is printed onto each of multiple sheets of paper supplied sequentially from the storage trays 20T, and the printed materials onto which images have been printed are inspected sequentially in the inspection device 30. Additionally, in the inspection device 30, printed materials with an inspection result of accepted are finished in the finishing device 40 and delivered into a predetermined delivery tray 40T.

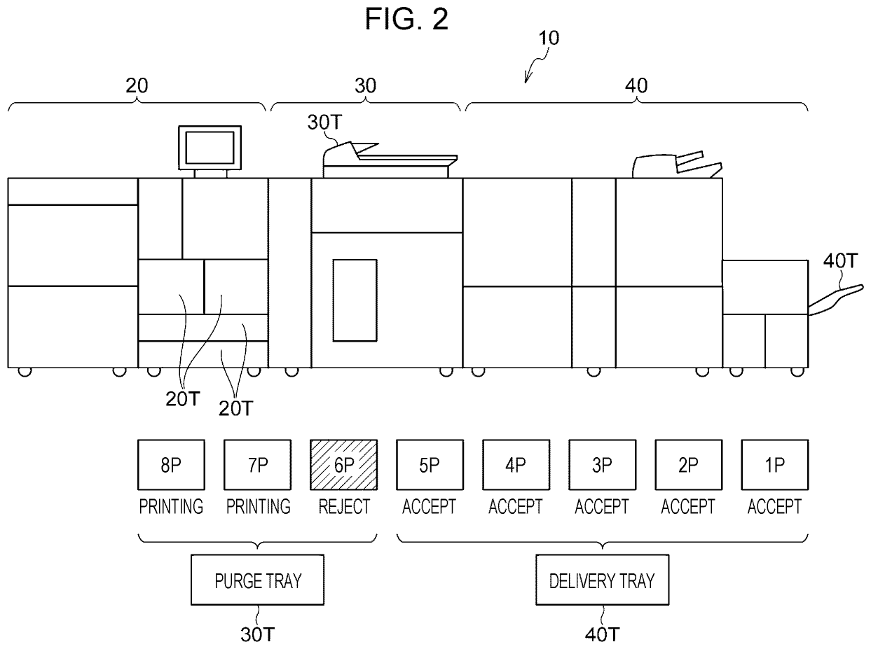

In this situation, as illustrated in FIG. 2, if printed material with an inspection result of rejected occurs in the inspection device 30 during continuous printing (printed material 6P), not only the rejected printed material but also the printed material (printed materials 7P and 8P) being printed next after the rejected printed material, or in other words, all paper sheets on the paper transport route (paper transport path) from the storage trays 20T to the inspection by the inspection device 30, will be delivered into the purge tray 30T.

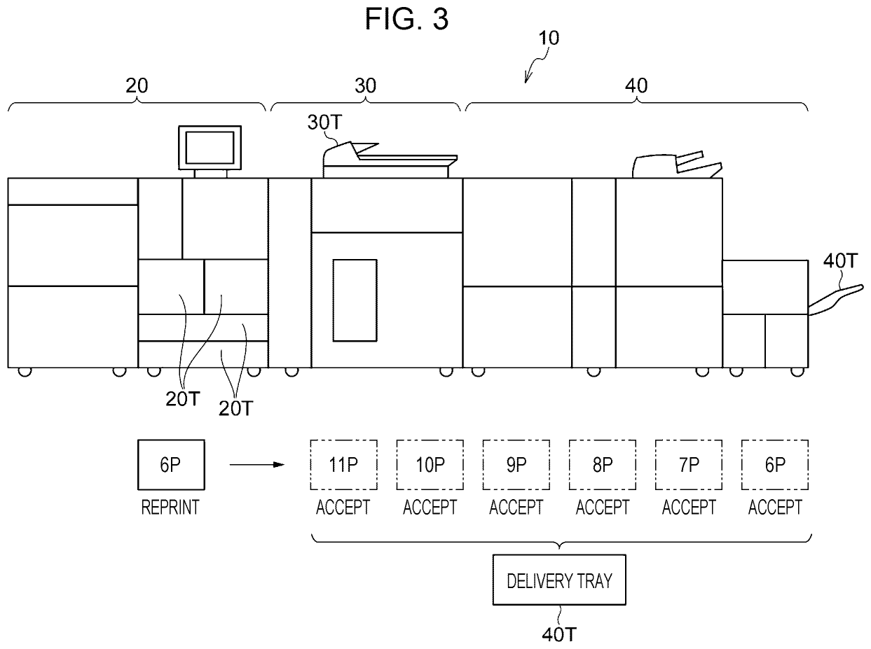

Thereafter, as illustrated in FIG. 3, continuous printing (reprinting) is resumed from the printed material (printed material 6P) that had an inspection result of rejected in the inspection device 30. Additionally, as indicated by the chain double-dashed lines in FIG. 3, reprinted material (printed material 6P) that has been accepted in the quality inspection by the inspection device 30 and the printed material (printed materials 7P-11P) next after the reprinted material are delivered into the delivery tray 40T of the finishing device 40. This is because in the case where printed material with an inspection result of rejected occurs in the inspection device 30, delivering only the rejected printed material (printed material 6P) into the purge tray 30T and delivering the printed material (printed materials 7P and 8P) being printed next after the rejected printed material into the delivery tray 40T of the finishing device 40 would result in the pages of the printed material being out of order in the delivery tray 40T.

However, as described above, in the case where printed material with an inspection result of rejected occurs during continuous printing, delivering not only the rejected printed material but also all printed materials being printed next after the rejected printed material results in an increase in the amount of waste paper (waste sheets) compared to the case where only the rejected printed material is delivered into the purge tray 30T.

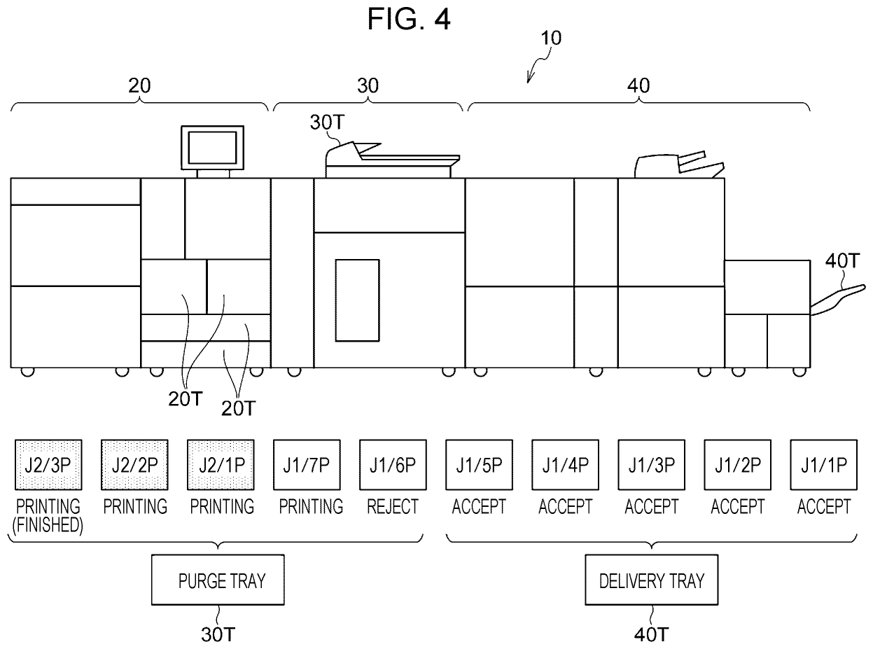

Also, in the case of continuously printing printed materials included in two print jobs (hereinafter simply referred to as jobs) with different content to be printed, as illustrated in FIG. 4, after the sheet (7P of J1) of the preceding job J1, a sheet (1P of J2) of the subsequent job J2 next after job J1 is supplied to the paper transport path. Each job contains information about a print image (print data), and printing conditions such as the paper size, type of paper, number of pages to print, and purge settings are set. In the purge settings, conditions related to the method of delivering printed material with an inspection result of rejected are set, including for example the presence or absence of inspection, the delivery destination of rejected printed material, and the method of printing after inspection rejection (automatic reprinting, halt printing, and the like).

As illustrated in FIG. 4, if printed material with an inspection result of rejected occurs in the inspection device 30 for job J1 (6P of J1), not only the rejected printed material but also the printed material (7P of J1) of job J1 as well as the printed material of job J2 (1P-3P of J2) being printed next after the rejected printed material, or in other words, all paper sheets on the paper transport path from the storage trays 20T to the inspection by the inspection device 30, will be delivered into the purge tray 30T.

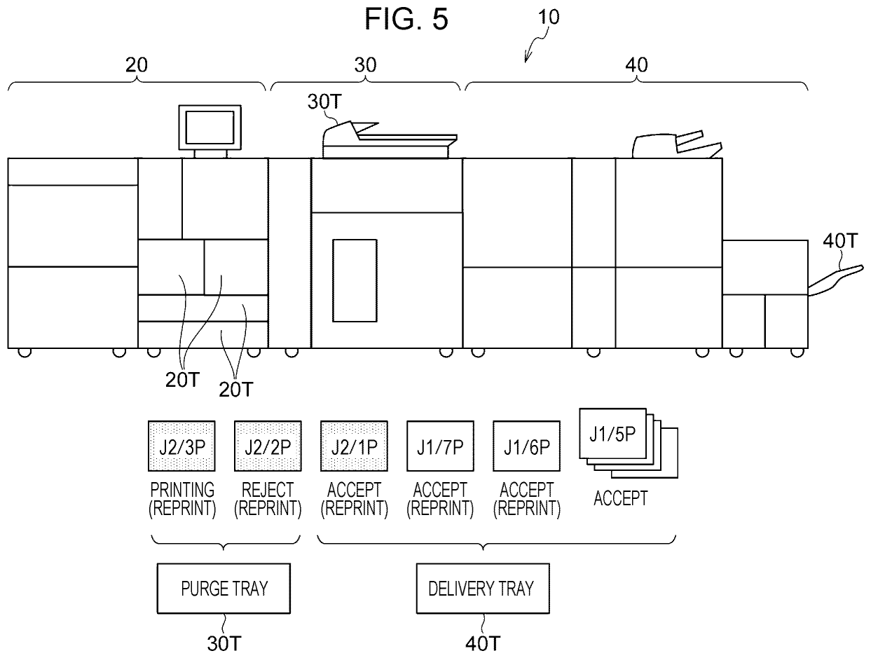

Thereafter, as illustrated in FIG. 5, continuous printing (reprinting) is resumed from the printed material (printed material 6P) that had an inspection result of rejected in the inspection device 30. Additionally, reprinted material (printed material 6P of J1) that has been accepted in the quality inspection by the inspection device 30 and the printed material of job J1 (printed material 7P of J1) and the printed material of job J2 (1P-3P of J2) next after the reprinted material are reprinted. Inspection is also performed in the inspection device 30 during reprinting, and when printed material with an inspection result of rejected occurs (printed material 2P of J2), the printed material being printed next after the rejected printed material is delivered into the purge tray 30T.

As illustrated in FIG. 5, if rejection further occurs with the printed material of job J2 (2P of J2) being reprinted, the printed material (3P of J2) being reprinted that is already on the paper transport path is delivered into the purge tray 30T in accordance with the purge settings for job J1. However, in the case where job J1 is such that the paper for printing is plain paper and the purge settings are set to automatic reprinting in the event of inspection rejection, while job J2 is such that the paper for printing is quality paper and the purge settings are set to wait for a user instruction (for example, reprinting, halt printing, or the like is set according to a user instruction) in the event of inspection rejection, if rejection occurs with the printed material of job J2, it is desirable to wait for a user instruction at that time, but since the printed material is delivered into the purge tray 30T in accordance with the purge settings for job J1, the amount of waste increases.

In particular, when reprinting printed material that has been rejected in the inspection device 30, there is a possibility that the printed material will be rejected again in the inspection device 30, and thus there is a possibility that the amount of waste paper will increase. Also, in the case of using quality paper as in job J2, the greater the increase in the amount of waste is, the greater the expense is.

Moreover, a longer paper transport path from the storage trays 20T to the inspection device 30 means that an increased number of paper sheets will be delivered into the purge tray 30T when printed material with an inspection result of rejected occurs in the inspection device 30.

Furthermore, a faster paper transport speed means that when printed material with an inspection result of rejected occurs in the inspection device 30, an increased number of paper sheets will remain in the paper transport path from the storage trays 20T to the inspection device 30, and therefore an increased number of paper sheets will be delivered into the purge tray 30T. Also, when printed material with an inspection result of rejected occurs in the inspection device 30, not only will the amount of waste paper increase, but the amount of toner used in printing and the printing time will also increase.

Accordingly, in the image forming system 10 according to the exemplary embodiment, subsequent printed material is printed while inspected print quality of printed material, and if it is determined not to continuously print the printed material of a subsequent job on the basis of purge settings related to the method of delivering printed material with an inspection result of rejected for the preceding job and the subsequent job, the printing of the printed material of the subsequent job is started after the preceding job is completed. The following describes the image forming system 10 according to the exemplary embodiment in detail.

### Hardware Configuration of Image Forming System

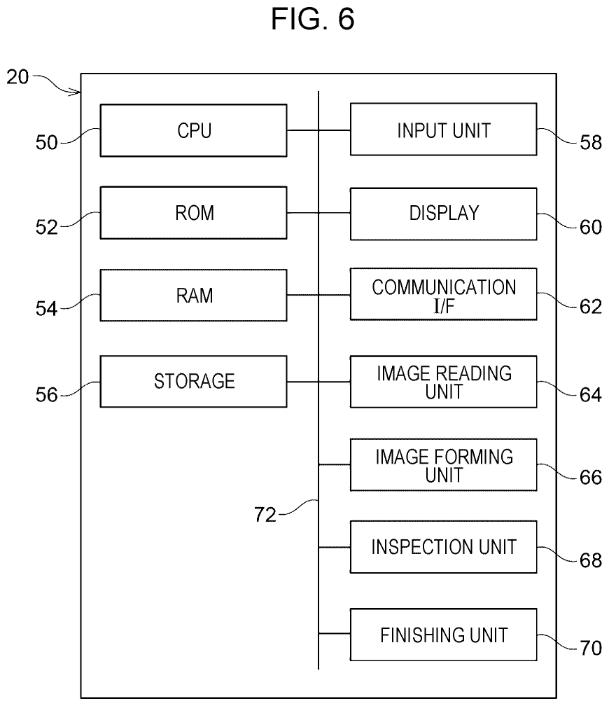

First, a hardware configuration of the image forming system 10 will be described. Note that although the following describes a hardware configuration of the image forming system 10 out of convenience, the printer 20, the inspection device 30, and the finishing device 40 may be separately provided with a hardware configuration like the one illustrated in FIG. 6.

As illustrated in FIG. 6, the image forming system 10 is provided with a computer including a central processing unit (CPU) 50, read-only memory (ROM) 52, random access memory (RAM) 54, a bus 72, storage 56, a communication interface (I/F) 62, and the like, and is further provided with each of an input unit 58, a display 60, an image reading unit 64, an image forming unit 66, an inspection unit 68, and a finishing unit 70.

The CPU 50 is a central processing unit that executes various programs and controls each unit. That is, the CPU 50 reads out a program from the ROM 52 or the storage 56, and executes the program while using the RAM 54 as a work area. The CPU 50 controls each unit as above and performs various arithmetic processing in accordance with the program recorded in the ROM 52 or the storage 56. Note that the CPU 50 is an example of a processor.

The ROM 52 stores various information processing programs and various data. The RAM 54 temporarily stores programs or data as a work area for the CPU 50.

The storage 56 includes a hard disk drive (HDD) or a solid-state drive (SSD), and stores various programs, including an operating system, as well as various data.

The input unit 58 includes operation buttons or the like, and is used to enter various inputs. The display 60 is a liquid crystal display, for example, and displays various information. The display 60 may also adopt a touch panel system and function as an input unit.

The communication I/F 62 is an interface for communicating with other equipment, and implements a standard such as Ethernet®, FDDI, or Wi-Fi®, for example.

The image reading unit 64 includes a scanner or the like, and optically reads image data from a document or the like. The image forming unit 66 prints image data onto a recording medium such as paper, the image data being image data read by the image reading unit 64 or received from an operating terminal not illustrated.

The inspection unit 68 includes a scanner or the like, and optically reads image data from paper (printed material) onto which an image has been printed by the image forming unit 66.

The finishing unit 70 includes various finishing mechanisms, such as mechanisms for performing folding, stapling, hole-punching, and booklet-making processes with respect to recording media such as paper, and finishes printed material that has been inspected by the inspection device 30.

### Functions of Image Forming System

Next, the functions of the image forming system 10 will be described.

When executing the information processing programs described above, the image forming system 10 uses the abovementioned hardware resources to realize the various functions of the printer 20, the inspection device 30, and the finishing device 40.

### Printer

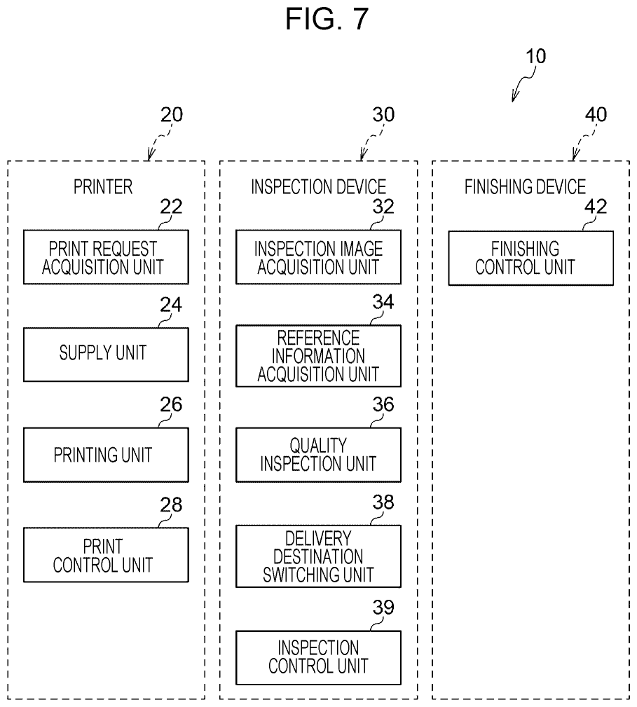

Specifically, as illustrated in FIG. 7, the printer 20 functionally includes a print request acquisition unit 22, a supply unit 24, a printing unit 26, and a print control unit 28.

The print request acquisition unit 22 acquires a print request (print job J) inputted to the image forming system 10, the print request including information (print data) on a print image, the paper size, and the number of pages to print, for example.

The supply unit 24 supplies to the printing unit 26 paper stored in a predetermined storage tray 20T among the multiple storage trays 20T. The printing unit 26 prints an image onto the paper supplied from the supply unit 24.

### Continuous Printing

The print control unit 28 executes continuous printing to control overall operations by the printer 20, print an image onto each of multiple paper sheets stored in the storage trays 20T, and sequentially supply the multiple printed materials that have been printed to the inspection device 30.

Specifically, the print control unit 28 controls the supply unit 24 on the basis of a print request acquired by the print request acquisition unit 22 and causes multiple paper sheets to be supplied sequentially to the printing unit 26 from a predetermined storage tray 20T among the multiple storage trays 20T. The print control unit 28 also transmits print data to be printed onto the multiple paper sheets to the printing unit 26. The print control unit 28 then causes an image based on the print data to be printed onto each of the multiple paper sheets supplied from the storage tray 20T in the printing unit 26, and the multiple printed materials that have been printed are supplied sequentially from the printing unit 26 to the inspection device 30.

Also, in continuous printing, the print control unit 28 transmits print data to be printed onto each of the multiple paper sheets to an inspection control unit 39 in the inspection device 30 described later.

### Reprinting

For example, as illustrated in FIG. 2, when printed material (printed material 6P) with an inspection result of rejected occurs in the inspection device 30, the print control unit 28 stops the continuous printing of printed materials and executes reprinting to print again only the printed material (printed material 6P) with an inspection result of rejected.

Specifically, the print control unit 28 controls the supply unit 24 on the basis of an inspection result received from the inspection control unit 39 described later, and causes one paper sheet to be supplied to the printing unit 26 from a predetermined storage tray 20T among the multiple storage trays 20T. The print control unit 28 then causes the image which resulted in an inspection result of rejected to be printed onto the one paper sheet supplied from the storage tray 20T in the printing unit 26, and the reprinted material (reprinted material 6P) that has been reprinted is supplied from the printing unit 26 to the inspection device 30.

If the reprinted material is given an inspection result of accepted by the inspection device 30, the print control unit 28 then resumes continuous printing of the printed material next after the reprinted material.

### Inspection Device

Functionally, the inspection device 30 is provided with an inspection image acquisition unit 32, a reference information acquisition unit 34, a quality inspection unit 36, a delivery destination switching unit 38, and an inspection control unit 39.

The inspection image acquisition unit 32 scans an image from printed material that has been printed in the printing unit 26, and generates an inspection image such as a rasterized image on the basis of the scanned image.

The reference information acquisition unit 34 receives print data transmitted from the print control unit 28 as a reference image.

The quality inspection unit 36 compares the inspection image read by the inspection image acquisition unit 32 with the reference image received by the reference information acquisition unit 34 and determines whether or not the printed material has an abnormality, that is, whether to accept or reject the print quality of the printed material.

Specifically, the quality inspection unit 36 compares the inspection image with the reference image to thereby determine whether or not there is an abnormality such as corner creases, printing smudges, or misalignment. Upon determining that the printed material does not have an abnormality, the quality inspection unit 36 accepts the printed material, whereas upon determining that the printed material has an abnormality, the quality inspection unit 36 rejects the printed material.

The delivery destination switching unit 38 switches the delivery destination of printed material inspected by the quality inspection unit 36 between the finishing device 40 and the purge tray 30T.

The inspection control unit 39 controls overall operations by the inspection device 30. Specifically, the inspection control unit 39 causes the quality inspection unit 36 to inspect the print quality of printed material or reprinted material. If the print quality of printed material or reprinted material is accepted by the quality inspection unit 36, the inspection control unit 39 uses the delivery destination switching unit 38 to switch the delivery destination of the printed material or reprinted material to the finishing device 40.

On the other hand, if the printed material or reprinted material has an inspection result of rejected as determined by the quality inspection unit 36, the inspection control unit 39 uses the delivery destination switching unit 38 to switch the delivery destination of the printed material or reprinted material to the purge tray 30T.

Additionally, the inspection control unit 39 transmits, to the print control unit 28, the inspection result determined by the quality inspection unit 36 and information such as which page (page number) of the printed material has been determined to be rejected.

### Finishing Device

Functionally, the finishing device 40 is provided with a finishing control unit 42. The finishing control unit 42 controls overall operations by the finishing device 40. Specifically, the finishing control unit 42 controls various finishing mechanisms, such as mechanisms for performing folding, stapling, hole-punching, and booklet-making processes, and finishes printed material supplied from the inspection device 30.

Note that the print control unit 28, the inspection control unit 39, and the finishing control unit 42 transmit and receive information with respect to each other, and thereby cooperate to control overall operations by the image forming system 10.

### Printing System

Next, a printing system 1 according to an exemplary embodiment will be described.

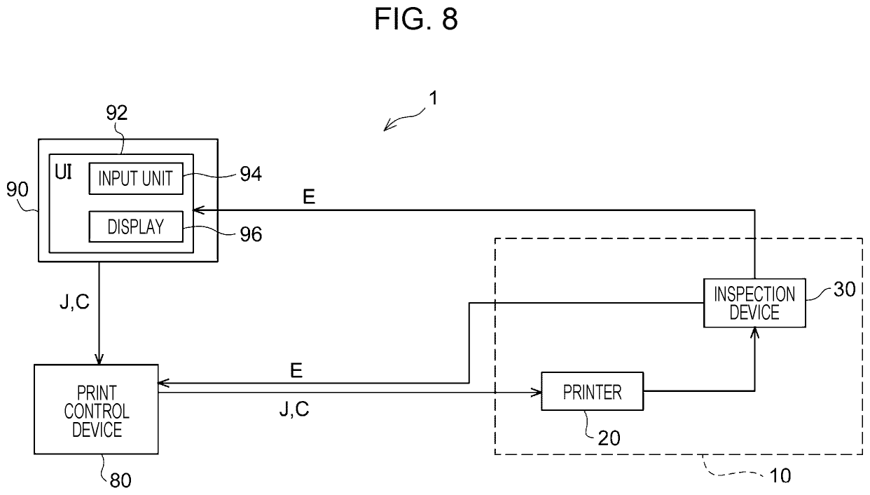

As illustrated in FIG. 8, the printing system 1 is provided with the image forming system 10, a print control device 80, and a user terminal 90. The print control device 80 is a computer with server functions, and is communicatively connected to the image forming system 10 and the user terminal 90 over a network. The network implements a standard such as Ethernet®, FDDI, or Wi-Fi®, for example. In FIG. 8, only one image forming system 10 and only one user terminal 90 are illustrated, but the print control device 80 may also be connected to multiple image forming systems 10 and multiple user terminals.

The user terminal 90 is a computer with communication functions, and is provided with an input unit 94 and a display 96. The input unit 94 includes operation buttons or the like, and is used to enter various inputs. The display 96 is a liquid crystal display, for example, and displays various information. The display 96 may also adopt a touch panel system and function as an input unit.

The print control device 80 receives a job J from the user terminal 90 and carries out control to transmit the received job J to the image forming system 10.

The print control device 80 also transmits printing conditions C set at the user terminal 90 to the appropriate image forming system 10. The printing conditions C include purge settings related to the method of delivering printed material.

The image forming system 10 receives the job J transmitted from the print control device 80 at the print request acquisition unit 22 of the printer 20 and starts a printing process. Also, the image forming system 10 stores the printing conditions C transmitted from the print control device 80 and executes the printing process according to the purge settings in the printing conditions C.

A result R of the inspection performed by the inspection device 30 of the image forming system 10 is transmitted to the print control device 80, and the inspection result R is stored in the print control device 80 in association with each job J. In the case where the inspection result R is rejection, error information E is transmitted to the user terminal 90. The error information E may be transmitted to the user terminal 90 via the print control device 80, but in the case where the image forming system 10 and the user terminal 90 are directly communicatively connected, the error information E may be transmitted directly from the image forming system 10 to the user terminal 90.

The user terminal 90 is provided with a user interface (UI) 92. The UI 92 is formed from the input unit 94 and the display 96, and is used to input the job J and the printing conditions C. The job J and printing conditions C inputted from the UI 92 are transmitted from the user terminal 90 to the print control device 80. Also, the user terminal 90 displays the error information E transmitted from the inspection device 30 on the UI 92.

### Purge Settings

Next, purge settings will be described.

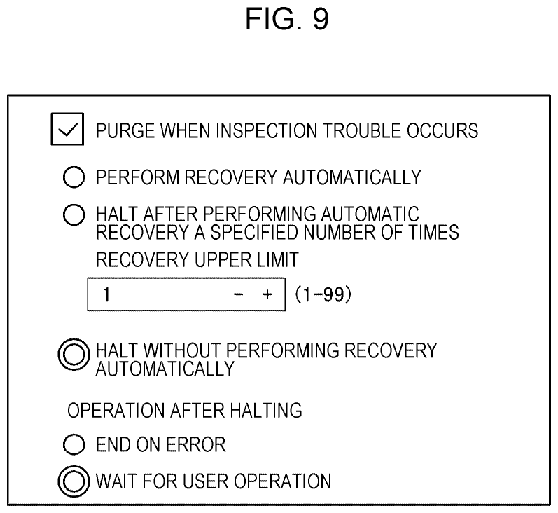

Purge settings are set on a per-job basis from the UI 92 of the user terminal 90. FIG. 9 illustrates an example of a purge settings screen displayed on the display 96. Purge settings are set by having the user use the input unit 94 to select radio buttons on the purge settings screen. The purge settings screen and the selection method are examples, and the configuration is not limited thereto.

Next, purge settings and the delivery destination of printed material in the image forming system 10 will be described. In the case where the purge settings have purge enabled (“Purge when inspection trouble occurs” is checked in FIG. 9), the image forming system 10 delivers printed material with an inspection result of accepted into the delivery tray 40T, and delivers printed material with an inspection result of rejected, as well as printed material printed next after the rejected printed material until printing is halted, into the purge tray 30T. In the case where the purge settings have purge disabled (“Purge when inspection trouble occurs” is not checked in FIG. 9), the image forming system 10 delivers all printed materials into the delivery tray 40T.

If purge is enabled, the purge settings further include a setting as to whether to execute reprinting automatically (“Perform recovery automatically” is checked), halt printing after a specified number of automatic reprinting attempts (“Halt after performing automatic recovery a specified number of times” is checked and the number of recovery attempts (1-99) in that event is specified), or halt printing without executing automatic reprinting (“Halt without performing recovery automatically” is checked) with respect to printed material with an inspection result of rejected. In the case of halting printing without executing automatic reprinting, the purge settings also include a setting as to whether to the operation after halting is to end on error or wait for a user operation.

If wait for a user operation is set, when printed material with an inspection result of rejected occurs in the inspection device 30, the print control unit 28 halts continuous printing in the image forming system 10 (halt printing) until input pertaining to a method of dealing with the halted printing is received from the input unit 58. In other words, printing is halted in a state with the printed material being printed also remaining in place on the paper transport path.

While printing is halted, if the user enters an operation to end on error into the printer 20 from the input unit 58, the inspection device 30 delivers the printed material being printed on the paper transport path into the purge tray 30T, and the print control unit 28 ends the preceding job J1 being printed and starts the printing of the subsequent job J2.

On the other hand, if the user enters an operation for reprinting (recovery) of the printing into the printer 20 from the input unit 58, the inspection device 30 delivers the printed material being printed on the paper transport path into the purge tray 30T, after which the print control unit 28 resumes continuous printing by reprinting the printed material with the inspection result of rejected and the next printed material after the rejected printed material.

### Continuous Printing of Preceding Job and Subsequent Job

The print control unit 28 performs continuous printing of the printed material of the subsequent job after the printed material of the preceding job by controlling the timings at which the supply unit 24 supplies paper to the paper transport path.

Specifically, in the case of performing continuous printing, as illustrated in FIG. 4, the print control unit 28 controls the supply unit 24 to supply the last paper sheet (7P of J1) of the preceding job J1 from a storage tray 20T to the paper transport path, and then supply the paper sheet (1P of J2) of the subsequent job J2 from a storage tray 20T to the paper transport path.

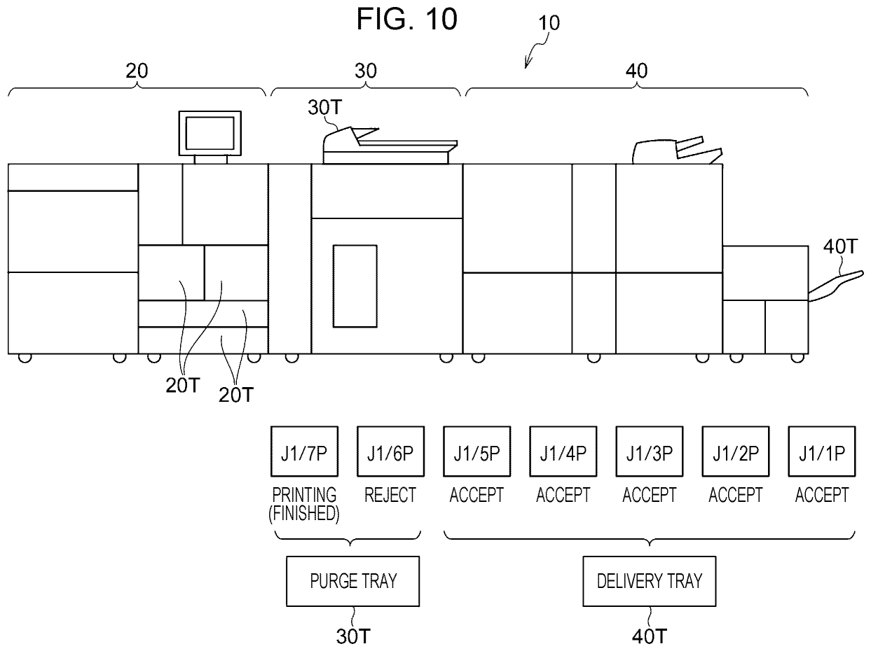

On the other hand, in the case of not performing continuous printing of the printed material of the subsequent job after the printed material of the preceding job, as illustrated in FIG. 10, the print control unit 28 controls the supply unit 24 to supply the last paper sheet of the preceding job J1 from a storage tray 20T to the paper transport path, and then not supply the paper of the subsequent job J2 to the paper transport path until the printed material of the preceding job J1 is entirely delivered into the delivery tray 40T (1P to 5P of J1) or the purge tray 30T (6P and 7P of J1). In other words, the print control unit 28 controls the supply unit 24 to start supplying the paper of the subsequent job J2 after the preceding job is completed. The printing of the subsequent job J2 is started by starting the supply of the paper of the subsequent job J2.

### Determining Continuous Printing of Preceding Job and Subsequent Job

Next, combinations of purge settings for the preceding job J1 and the subsequent job J2 and a method for determining whether or not to perform continuous printing will be described.

First, if the preceding job and the subsequent job have matching purge settings, the print control unit 28 determines to perform continuous printing of the printed material of the subsequent job.

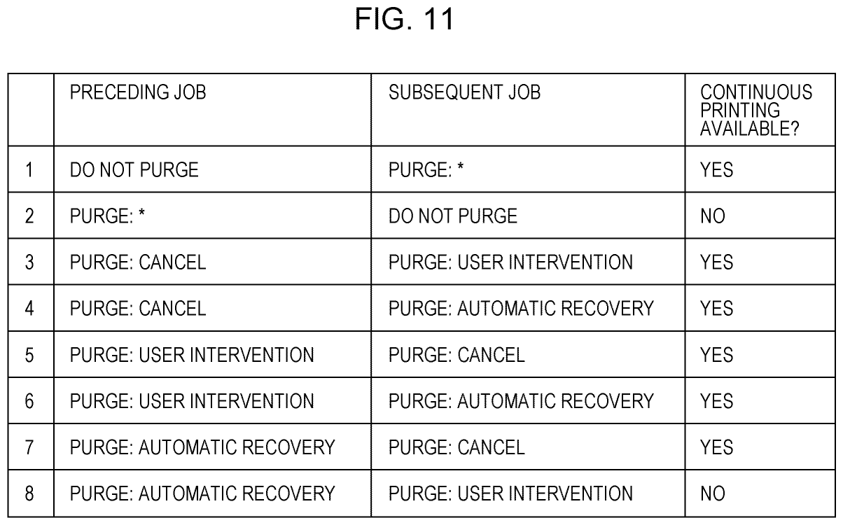

If the preceding job J1 and the subsequent job J2 have different purge settings, the print control unit 28 determines whether or not to perform continuous printing on the basis of a table stored in the printer 20. FIG. 11 illustrates an example of a table illustrating correspondences between combinations of purge settings for the preceding job J1 and the subsequent job J2 and the availability of continuous printing. These combinations may be stored in advance in the printer 20 as defaults.

As indicated on the first row in FIG. 11, when the preceding job J1 is set to purge disabled and the subsequent job J2 is set to purge enabled, the print control unit 28 determines to perform continuous printing of the printed material of the subsequent job. Even if rejected printed material occurs in the preceding job J1, if the purge settings for the preceding job J1 have purge disabled, the printed material of the subsequent job J2 will not be delivered into the purge tray 30T, and therefore the amount of waste printed material will not increase even if the subsequent job J2 is printed continuously.

As indicated on the second row in FIG. 11, when the purge settings for the preceding job J1 are set to purge enabled and the purge settings for the subsequent job J2 are set to purge disabled, the print control unit 28 determines not to perform continuous printing of the printed material of the subsequent job. The subsequent job J2 is not printed continuously because if rejected printed material occurs in the preceding job J1, the printed material of the subsequent job J2 will also be delivered into the purge tray 30T in accordance with the purge settings for the preceding job J1, and the amount of waste printed material will increase.

As indicated on the eighth row in FIG. 11, when the purge settings for the preceding job J1 and the subsequent job J2 are set to purge enabled, automatic reprinting (“automatic recovery”) is set in the preceding job J1, and wait for user instruction (“user intervention”) is set in the subsequent job J2, the print control unit 28 determines not to perform continuous printing of the printed material of the subsequent job. The subsequent job J2 is not printed continuously because, as described using FIG. 4, if rejected printed material occurs in the preceding job J1, the printed material of job J2 will be delivered into the purge tray 30T in accordance with the purge settings for job J1, and the amount of waste printed material will increase.

As indicated on the third row in FIG. 11, when both the preceding job J1 and the subsequent job J2 are set to purge enabled and the operation in the event of a rejection occurring with the printed material is set to halt printing (“cancel”) in the preceding job J1 and wait for user instruction in the subsequent job J2, the print control unit 28 determines to perform continuous printing. Similarly, as indicated on the fourth row in FIG. 11, when both the preceding job J1 and the subsequent job J2 are set to purge enabled and the operation in the event of a rejection occurring with the printed material is set to halt printing in the preceding job J1 and automatic reprinting in the subsequent job J2, the print control unit 28 determines to perform continuous printing. In the preceding job J1, the printing of job J1 is halted if rejected printed material occurs, and therefore the printed material delivered into the purge tray 30T will not increase even if the subsequent job J2 is printed continuously.

As indicated on the fifth row in FIG. 11, when both the preceding job J1 and the subsequent job J2 are set to purge enabled and the operation in the event of a rejection occurring with the printed material is set to wait for user instruction in the preceding job J1 and halt printing in the subsequent job J2, the print control unit 28 determines to perform continuous printing. Similarly, as indicated on the sixth row in FIG. 11, when both the preceding job J1 and the subsequent job J2 are set to purge enabled and the operation in the event of a rejection occurring with the printed material is set to wait for user instruction in the preceding job J1 and automatic reprinting in the subsequent job J2, the print control unit 28 determines to perform continuous printing. In the preceding job J1, the printing of job J1 waits for a user instruction if rejected printed material occurs, and therefore the printed material delivered into the purge tray 30T will not increase even if the subsequent job J2 is printed continuously.

As indicated on the seventh row in FIG. 11, when both the preceding job J1 and the subsequent job J2 are set to purge enabled and the operation in the event of a rejection occurring with the printed material is set to automatic reprinting in the preceding job J1 and halt printing in the subsequent job J2, the print control unit 28 determines to perform continuous printing. In the preceding job J1, if rejected printed material occurs, the printing of job J1 is reprinted, but printing is halted in the subsequent job J2, and therefore the printed material delivered into the purge tray 30T will not increase even if the subsequent job J2 is printed continuously.

### Changing Purge Settings

Furthermore, a configuration may be adopted such that the determination of whether or not to perform continuous printing when the preceding job J1 and the subsequent job J2 have different purge settings may be changed according to user settings.

Specifically, user input from the UI 92 of the user terminal 90 is accepted, the conditions on whether or not to perform continuous printing according to the purge settings for the preceding job and the subsequent job are changed, and the changed conditions are stored in the printer. The print control unit 28 follows the newly stored conditions to determine, on the basis of the purge settings for the preceding job and the subsequent job, whether to perform continuous printing of the printed material of the subsequent job after the printed material of the preceding job or to start the printing of the printed material of the subsequent job after the preceding job is completed.

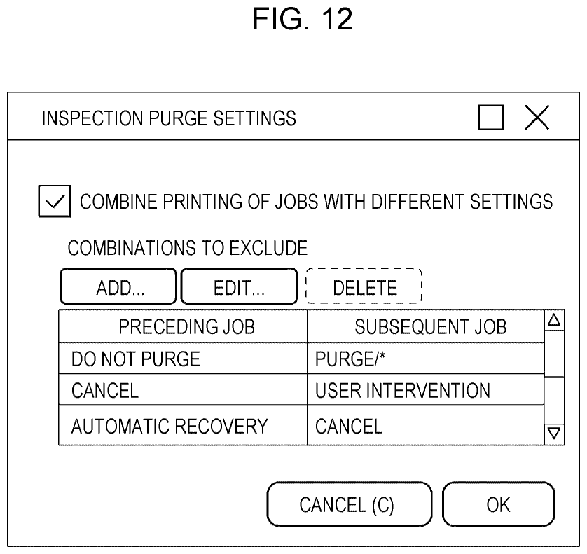

FIG. 12 is an example of an input screen for changing the combinations of purge settings for the preceding job J1 and the subsequent job J2 for which continuous printing is not to be performed when the preceding job J1 and the subsequent job J2 have different purge settings.

Specifically, the input screen in FIG. 12 is displayed on the display 96 of the user terminal 90, and combinations set by the user using the input unit 94 are transmitted from the user terminal 90 to the print control device 80 and stored on a per-user basis. Additionally, the print control device 80 transmits the changed combinations to the printer 20.

In the printer 20, the changed combinations received from the print control device 80 are stored on a per-user basis. Additionally, the print control unit 28 follows the changed combinations to determine whether or not to perform continuous printing of the preceding job J1 and the subsequent job J2.

### Continuous Printing in Image Forming System

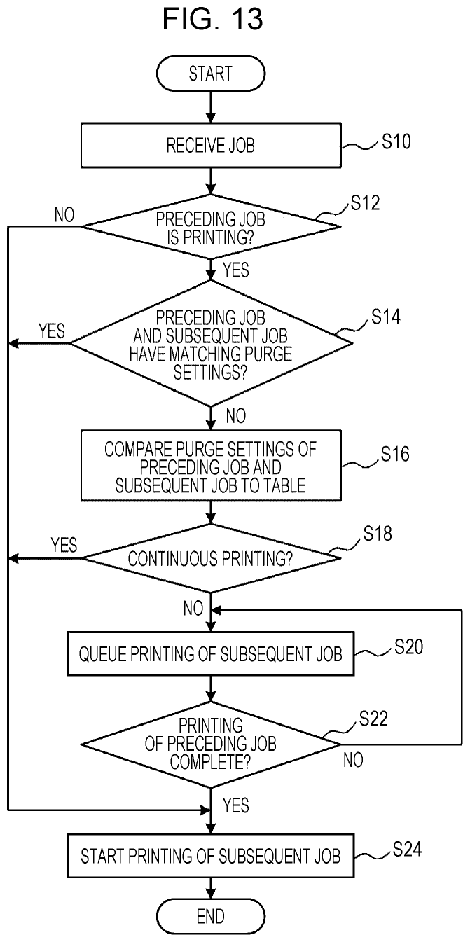

Next, the flow of a process of continuous printing by the image forming system 10 will be described using the flowchart in FIG. 13.

In the image forming system 10, when jobs J are received from the user terminal 90, the printing of printed material is started in the order of arrival. When a job J arrives at the printer 20, the printing process illustrated in FIG. 13 is executed in the image forming system 10.

First, in step S10, the CPU 50 receives a job J.

Next, in step S12, the CPU 50 determines whether or not there is a job (hereinafter referred to as the preceding job J1) being printed by the printer prior to the received job (hereinafter referred to as the subsequent job J2). If the preceding job J1 has already completed printing (step S12, NO), the CPU 50 proceeds to step S24 and starts the printing of the subsequent job J2. If the preceding job J1 is being printed (step S12, YES), the CPU 50 proceeds to step S14.

Next, in step S14, the CPU 50 determines whether or not the purge settings for the preceding job J1 and the purge settings for the subsequent job J2 match. If the preceding job J1 and the subsequent job J2 have matching purge settings (step S14, YES), the CPU 50 proceeds to step S24 and starts the printing of the subsequent job J2 to perform continuous printing. If the preceding job J1 and the subsequent job J2 do not have matching purge settings, the CPU 50 proceeds to step S16 and compares the purge settings for the preceding job J1 and the subsequent job J2 to a table (see FIG. 11) in which the availability of continuous printing is recorded.

Next, in step S18, upon determining to perform continuous printing, the CPU 50 proceeds to step S24 and starts the printing of the subsequent job J2 to perform continuous printing. In step S18, upon determining not to perform continuous printing, the CPU 50 proceeds to step S20 and queues printing of the subsequent job J2 until the printing of the preceding job J1 is completed.

In step S22, the CPU 50 determines whether or not the printing of the preceding job J1 is completed, and keeps the subsequent job J2 in a printing-queued state until the printing of the preceding job J1 is completed (step S20). In step S22, if it is determined that the printing of the preceding job J1 is completed, the CPU 50 proceeds to step S24 and starts the printing of the subsequent job J2.

In the exemplary embodiment above, the term “processor” refers to hardware in a broad sense. Examples of the processor include general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed. Also, the processor may be partially or entirely configured in the cloud. At least each process described in the exemplary embodiment above may be executed by a processor in the cloud.

Also, the exemplary embodiment above describes a form in which each program is preinstalled in a computer, but is not limited thereto. Each program according to the exemplary embodiment above may also be provided by being recorded onto a computer-readable storage medium. For example, each program according to the exemplary embodiment above may be provided by being recorded on an optical disc, such as a Compact Disc-Read-Only Memory (CD-ROM) or a Digital Versatile Disc-Read-Only Memory (DVD-ROM), or by being recorded on a semiconductor memory, such as Universal Serial Bus (USB) memory or a memory card. Also, each program according to the exemplary embodiment above may be acquired from an external apparatus via a communication I/F.

Also, the exemplary embodiment above describes a case in which the processing in the image forming system 10 is achieved by a software configuration using a computer by executing a program, but the present disclosure is not limited thereto. For example, the processing in the image forming system 10 may also be achieved by a hardware configuration, or by a combination of a hardware configuration and a software configuration.

Otherwise, the configuration of the image forming system 10 described in the exemplary embodiment above is an example, and obviously, unnecessary portions may be removed or new portions may be added within a scope that does not depart from the gist of the present disclosure.

Also, the flow of the processing in the image forming system 10 described in the exemplary embodiment above is an example, and obviously, unnecessary steps may be removed, new steps may be added, or the processing sequence may be rearranged within a scope that does not depart from the gist of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system comprising:
a processor configured to:
   print subsequent printed material while inspecting print quality of printed material; and
   in a case of not continuously printing the printed material of a subsequent job after a preceding job on the basis of purge settings related to a method of delivering printed material with an inspection result of rejected for the preceding job and the subsequent job, start the printing of the printed material of the subsequent job after the preceding job is completed.
      (((2)))

The information processing system according to (((1))), wherein the processor is configured to:
in a case where the purge settings have purge enabled, deliver the printed material with an inspection result of accepted into a printed material delivery unit, and deliver the printed material with an inspection result of rejected, as well as printed material printed next after the rejected printed material until printing is halted, into a reject delivery unit;
in a case where the purge settings have purge disabled, deliver all printed material into the printed material delivery unit; and
   in the case of not continuously printing the printed material of the subsequent job, start the printing of the printed material of the subsequent job after the printed material of the preceding job is entirely delivered into the printed material delivery unit or the reject delivery unit.
      (((3)))

The information processing system according to (((2))), wherein the processor is configured to:
in a case where the purge settings have purge enabled and there is printed material with an inspection result of rejected, reprint the printed material delivered into the reject delivery unit; and
in the case of not continuously printing the printed material of the subsequent job, start the printing of the printed material of the subsequent job after all of the printed material of the preceding job is accepted and delivered into the printed material delivery unit.
   (((4)))

The information processing system according to (((2))), wherein the processor is configured to:
in a case where the preceding job is set to purge enabled and the subsequent job is set to purge disabled, not continuously print the printed material of the subsequent job.
   (((5)))

The information processing system according to (((2))), wherein:
in the case where the purge settings have purge enabled, the purge settings include settings to automatically reprint rejected printed material, to halt the printing of rejected printed material and any printing thereafter, and to wait for a user instruction regarding rejected printed material, and
the processor is configured to:
   in a case where the purge settings for the preceding job and the subsequent job are set to purge enabled, automatic reprinting is set in the preceding job, and wait for user instruction is set in the subsequent job, not continuously print the printed material of the subsequent job.
      (((6)))

The information processing system according to (((4))), wherein the processor is configured to:
in a case where the preceding job and the subsequent job have matching purge settings, continuously print the printed material of the subsequent job.
   (((7)))

The information processing system according to (((5))), wherein the processor is configured to:
in a case where the purge settings for the preceding job and the subsequent job are set to purge enabled, wait for user instruction is set in the preceding job, and automatic reprinting is set in the subsequent job, continuously print the printed material of the subsequent job.
   (((8)))

The information processing system according to any one of (((1))) to (((7))), wherein the processor is configured to:
accept user input and change a condition on whether or not to perform continuous printing according to the purge settings for the preceding job and the subsequent job; and
follow the changed condition and perform continuous printing of the printed material of the subsequent job after the printed material of the preceding job or start the printing of the printed material of the subsequent job after the preceding job is completed, on the basis of the purge settings for the preceding job and the subsequent job.
   (((9)))

A program causing a computer to execute a process for information processing, the process comprising:
printing subsequent printed material while inspecting print quality of printed material; and
in a case of not continuously printing the printed material of a subsequent job after a preceding job on the basis of purge settings related to a method of delivering printed material with an inspection result of rejected for the preceding job and the subsequent job, starting the printing of the printed material of the subsequent job after the preceding job is completed.

What is claimed is:

1. An information processing system comprising:
a processor configured to:
print subsequent printed material while inspecting print quality of printed material; and
in a case of not continuously printing the printed material of a subsequent job after a preceding job on the basis of purge settings related to a method of delivering printed material with an inspection result of rejected for the preceding job and the subsequent job, start the printing of the printed material of the subsequent job after the preceding job is completed.

2. The information processing system according to claim 1, wherein the processor is configured to:
in a case where the purge settings have purge enabled, deliver the printed material with an inspection result of accepted into a printed material delivery unit, and deliver the printed material with an inspection result of rejected, as well as printed material printed next after the rejected printed material until printing is halted, into a reject delivery unit;
in a case where the purge settings have purge disabled, deliver all printed material into the printed material delivery unit; and
in the case of not continuously printing the printed material of the subsequent job, start the printing of the printed material of the subsequent job after the printed material of the preceding job is entirely delivered into the printed material delivery unit or the reject delivery unit.

3. The information processing system according to claim 2, wherein the processor is configured to:
in a case where the purge settings have purge enabled and there is printed material with an inspection result of rejected, reprint the printed material delivered into the reject delivery unit; and
in the case of not continuously printing the printed material of the subsequent job, start the printing of the printed material of the subsequent job after all of the printed material of the preceding job is accepted and delivered into the printed material delivery unit.

4. The information processing system according to claim 2, wherein the processor is configured to:
in a case where the preceding job is set to purge enabled and the subsequent job is set to purge disabled, not continuously print the printed material of the subsequent job.

5. The information processing system according to claim 2, wherein:
in the case where the purge settings have purge enabled, the purge settings include settings to automatically reprint rejected printed material, to halt the printing of rejected printed material and any printing thereafter, and to wait for a user instruction regarding rejected printed material, and
the processor is configured to:
in a case where the purge settings for the preceding job and the subsequent job are set to purge enabled, automatic reprinting is set in the preceding job, and wait for user instruction is set in the subsequent job, not continuously print the printed material of the subsequent job.

6. The information processing system according to claim 4, wherein the processor is configured to:
in a case where the preceding job and the subsequent job have matching purge settings, continuously print the printed material of the subsequent job.

7. The information processing system according to claim 5, wherein the processor is configured to:
in a case where the purge settings for the preceding job and the subsequent job are set to purge enabled, wait for user instruction is set in the preceding job, and automatic reprinting is set in the subsequent job, continuously print the printed material of the subsequent job.

8. The information processing system according to claim 1, wherein the processor is configured to:
accept user input and change a condition on whether or not to perform continuous printing according to the purge settings for the preceding job and the subsequent job; and
follow the changed condition and perform continuous printing of the printed material of the subsequent job after the printed material of the preceding job or start the printing of the printed material of the subsequent job after the preceding job is completed, on the basis of the purge settings for the preceding job and the subsequent job.

9. The information processing system according to claim 2, wherein the processor is configured to:
accept user input and change a condition on whether or not to perform continuous printing according to the purge settings for the preceding job and the subsequent job; and
follow the changed condition and perform continuous printing of the printed material of the subsequent job after the printed material of the preceding job or start the printing of the printed material of the subsequent job after the preceding job is completed, on the basis of the purge settings for the preceding job and the subsequent job.

10. The information processing system according to claim 3, wherein the processor is configured to:
accept user input and change a condition on whether or not to perform continuous printing according to the purge settings for the preceding job and the subsequent job; and
follow the changed condition and perform continuous printing of the printed material of the subsequent job after the printed material of the preceding job or start the printing of the printed material of the subsequent job after the preceding job is completed, on the basis of the purge settings for the preceding job and the subsequent job.

11. The information processing system according to claim 4, wherein the processor is configured to:
accept user input and change a condition on whether or not to perform continuous printing according to the purge settings for the preceding job and the subsequent job; and
follow the changed condition and perform continuous printing of the printed material of the subsequent job after the printed material of the preceding job or start the printing of the printed material of the subsequent job after the preceding job is completed, on the basis of the purge settings for the preceding job and the subsequent job.

12. The information processing system according to claim 5, wherein the processor is configured to:
accept user input and change a condition on whether or not to perform continuous printing according to the purge settings for the preceding job and the subsequent job; and
follow the changed condition and perform continuous printing of the printed material of the subsequent job after the printed material of the preceding job or start the printing of the printed material of the subsequent job after the preceding job is completed, on the basis of the purge settings for the preceding job and the subsequent job.

13. The information processing system according to claim 6, wherein the processor is configured to:
accept user input and change a condition on whether or not to perform continuous printing according to the purge settings for the preceding job and the subsequent job; and
follow the changed condition and perform continuous printing of the printed material of the subsequent job after the printed material of the preceding job or start the printing of the printed material of the subsequent job after the preceding job is completed, on the basis of the purge settings for the preceding job and the subsequent job.

14. The information processing system according to claim 7, wherein the processor is configured to:
accept user input and change a condition on whether or not to perform continuous printing according to the purge settings for the preceding job and the subsequent job; and
follow the changed condition and perform continuous printing of the printed material of the subsequent job after the printed material of the preceding job or start the printing of the printed material of the subsequent job after the preceding job is completed, on the basis of the purge settings for the preceding job and the subsequent job.

15. An information processing method comprising:
printing subsequent printed material while inspecting print quality of printed material; and
in a case of not continuously printing the printed material of a subsequent job after a preceding job on the basis of purge settings related to a method of delivering printed material with an inspection result of rejected for the preceding job and the subsequent job, starting the printing of the printed material of the subsequent job after the preceding job is completed.

16. A non-transitory computer readable medium storing a program causing a computer to execute a process for information processing, the process comprising:
printing subsequent printed material while inspecting print quality of printed material; and
in a case of not continuously printing the printed material of a subsequent job after a preceding job on the basis of purge settings related to a method of delivering printed material with an inspection result of rejected for the preceding job and the subsequent job, starting the printing of the printed material of the subsequent job after the preceding job is completed.
